(19) United States
(12) Patent Application Publication
(10) Pub. No.: US 2013/0166189 A1
(43) Pub. Date: Jun. 27, 2013

(54) ON-BOARD SYSTEM TO ASSIST THE TAXIING OF AN AIRCRAFT ON AIRPORT TAXIWAYS

(71) Applicant: Thales, Neuilly Sur Seine (FR)

(72) Inventors: Francois MICHEL, Saint Medard En Jalles (FR); Stephanie LAFON, Merignac (FR); Bernard DUBOURG, Le Haillan (FR); Michel SOLER, Carbon-Blanc (FR)

(73) Assignee: Thales, Neuilly Sur Seine (FR)

(21) Appl. No.: 13/655,217

(22) Filed: Oct. 18, 2012

(30) Foreign Application Priority Data
Oct. 21, 2011 (FR) 1103230

(51) Int. Cl. G08G 5/00

(52) U.S. Cl. CPC G08G 5/0043
USPC 701/120

(57) ABSTRACT

The invention relates to an on-board optoelectronic system to assist the taxiing of an aircraft on the taxiways of an airport, that includes:
a database (2) of maps of the airport,
a device (1) for positioning the aircraft, and
a device (3) for generating first graphical data representing a “moving map”.
a graphical data display device (4),
a database (5) describing the features of the cockpit,
a device (7) for generating second graphical data as a function of the said features, representing a zone of visibility from the cockpit by means of a mask (30), and
means of superimposition (8) of the second graphical data on the first graphical data, connected to the display device (4).

### BACKGROUND OF THE INVENTION

1. Field of the Invention

The field of the invention is that of assisting the taxiing of an aircraft on the taxiways of an airport.

2. Description of the Invention

Airports are at present a bottleneck for increasingly dense traffic. The growth in their capacity results in a complexity of the network of runways, taxiways and embarkation areas. It is therefore increasingly common for incidents to occur in which aircraft use paths that do not conform to the itinerary sent by ground control via the radio. The possibility of incidents of course increases in bad weather or in bad visibility conditions. It is therefore of fundamental importance that the pilot of the aircraft knows very precisely where his aircraft is located in the airport zone and that he knows perfectly the route he will have to take and the manoeuvres that he will have to carry out.

From the pilot's point of view, the position of the aircraft in an airport zone is currently obtained by a consultation of external indicators on or in the vicinity of taxiing zones. In order to increase the safety and efficiency of the taxiing phases, this perception of positioning is correlated with the indications coming from an on-board taxiing assistance system of the “moving-map” type which makes it possible to display a horizontal map of the airport zone (plan or “bird's eye” view) showing the current position of the aircraft: this allows the pilot to improve his general perception of the situation.

This taxiing assistance system uses location of the aircraft by position data determined by systems of the GPS (Global Positioning System) type and/or the inertial system of the aircraft. An example of a taxiing assistance system is described with reference to FIG. 1. From positioning of the aircraft information supplied by a positioning device 1 of the GPS type, possibly from display parameters selected by the pilot (scale or zoom factor, size of the display window, position of the aircraft on the display screen (fixed at the centre, at the bottom or at the top, etc., with the map scrolling or with the map fixed and the aircraft moving), etc.), from an interface 9 and from a horizontal map of the airport zone provided by a database 2, a device 3 generates “moving map” graphical data, transmitted to a display device 4 comprising a display screen (or “Navigation Display”). An example of a “moving map” symbolic representation 20 displayed on a display screen with the position of the aircraft 10 is shown in FIG. 2.

Among these taxiing assistance systems of the “moving map” type can be mentioned the EFB (Electronic Flight Bag) systems which are applications used by the pilots on portable computers for preparing their flights and which are not part of the on-board avionics, or specific products like the OANS (On-Board Airport Navigation), The acquisition and display of routing is also designed in systems of the ATNS (Airport Taxiway Navigation System) type, an example of which is described in the patent application US 2005/0283305.

The correlation between the displayed external elements (intersections of taxiways, other aircraft) and the external view the pilot has is sometimes difficult. In the case of complex intersections, dense traffic conditions and poor visibility, the pilot can have difficulty in matching the information displayed on the screen with that of the outside world. In complex airport configurations for example, it is not obvious to the pilot, based solely on the displayed representation, to know if he is on a given intersection of if he has passed it; he can in fact confuse it with the following one In fact, on large aircraft, the first visible point is located well in front of the nose of the aircraft: at about 20 metres for an A380 for example, as shown in FIG. 4a.

### SUMMARY OF THE INVENTION

The purpose of the invention is to overcome these disadvantages.

The invention makes it possible to represent the pilot's field of vision on the “moving map” by a semi-opaque mask covering the invisible part of the airport.

More precisely, the invention relates to an on-board optoelectronic system to assist the taxiing of an aircraft on the taxiways of an airport, which comprises:
a database of geographical maps of the airport as seen from above,
a device for positioning the aircraft, and
a device for generating first graphical data representing a map of the airport as seen from above and the current position of the aircraft on the said map, called “moving map” graphical data,
a graphical data display device.

It is principally characterized in that, with the aircraft comprising a cockpit, it furthermore comprises:
a database describing the features of the cockpit of the aircraft,
a device for generating second graphical data according to the said features, representing a zone of visibility from the cockpit by means of a mask, and
means of superimposition of the second graphical data on the first graphical data, connected to the display device.

This zone of visibility represents what the pilot sees; it takes into account the blind angles which depend on the arrangement of the cockpit. The zone of visibility can moreover take into account the outside visibility conditions (fog) generally given by the ATC (Air Traffic Control) system.

The representation of the pilot's field of view on the “moving map” makes it possible to limit the search for an object outside of the zone shown on the display screens.

It also makes it possible to simplify the cross-checks between the two pilots. In fact, if for example the field of vision of the pilot who is manoeuvring the aircraft is represented on the map of the pilot who is supervising the navigation, then the latter can indicate the important elements of the landscape (dangerous aircraft, intersection to take, etc.) at the appropriate time.

According to a feature of the invention, the features of the cockpit relate to the shape and/or the height of the cockpit and/or the shape of the windows.

It advantageously comprises a module for determining the position of the pilot's eyes connected to the device for generating second graphical data, the zone of visibility being determined as a function of the position of the pilot's eyes.

The device for generating second graphical data is possibly connected to:
a warning system, the second graphical data comprising information on the surrounding traffic coming from this warning system, and/or to
a head up sight, the second graphical data comprising information on the surrounding traffic coming from the head up sight, and/or to
an air traffic control system, the second graphical data comprising information on visibility conditions, notably poor visibility conditions such as fog.

According to a feature of the invention, the mask comprises delimitations delimiting sub-zones of the zone of visibility.

By the representation of the limits of this zone, the pilot is offered immediate references making it possible to find the object easily. For example, this aircraft is completely on my right and therefore it must be shown in the right limit of the zone of visibility. Conversely, if an aircraft is indicated by air traffic control but is outside of the field of vision, this prevents the pilot from carrying out a useless search until the indicated aircraft enters the field of vision.

### BRIEF DESCRIPTION OF THE DRAWINGS

Other features and advantages of the invention will appear on reading the following detailed description, given by way of non-limiting example and with reference to the appended drawings in which:

FIG. 1, already described, is a block diagram of the main elements of a system to assist the taxiing of an aircraft according to the prior art,

FIG. 2 shows an example of a “moving map” symbolic representation displayed on a screen, according to the prior art,

the FIGS. 3 show an example of a “moving map” with a mask representing the pilot's field of vision, displayed on a display screen (FIG. 3A) and its symbolic representation (FIG. 3B), according to the invention,

the FIGS. 4 illustrate the angles of visibility from the cockpit on a airport taxiway according to a plane perpendicular to the taxiway and to a side view of the plane (FIG. 4A), according to a plane parallel to the taxiway and to a top view of the plane (FIG. 4B), depending on the pilot or the co-pilot position, and according to a plane perpendicular to the taxiway and to a front view of the plane (FIG. 4C),

FIG. 5 shows an example of a “moving map” with a mask furthermore comprising delimitations corresponding to the windows,

FIG. 6 shows an example of a “moving map” with a mask corresponding to the zone of visibility through the window in front of the pilot,

FIG. 7 is a block diagram of an example of a system to assist taxiing according to the invention,
the FIGS. 8A and 8B show a symbolic representation of a “moving map” with a mask whose segments delimiting it are modified according to threats.

The same elements are given the same references in all of the figures.

### DETAILED DESCRIPTION

FIG. 3A shows an example of a mask 30 representing on the “moving map” 20 the pilot's field of vision (also called zone of visibility) through all of the windows, this preferably semi-opaque mask therefore covering the invisible part of the airport. A corresponding diagrammatic representation is shown in FIG. 3B. This mask comprises at least two parts:
one of them 31 determined from first visible points in front of the nose of the aircraft 10,
the other one 32 which is shown in relative bearing in the form of an angular portion with extends from the first part.

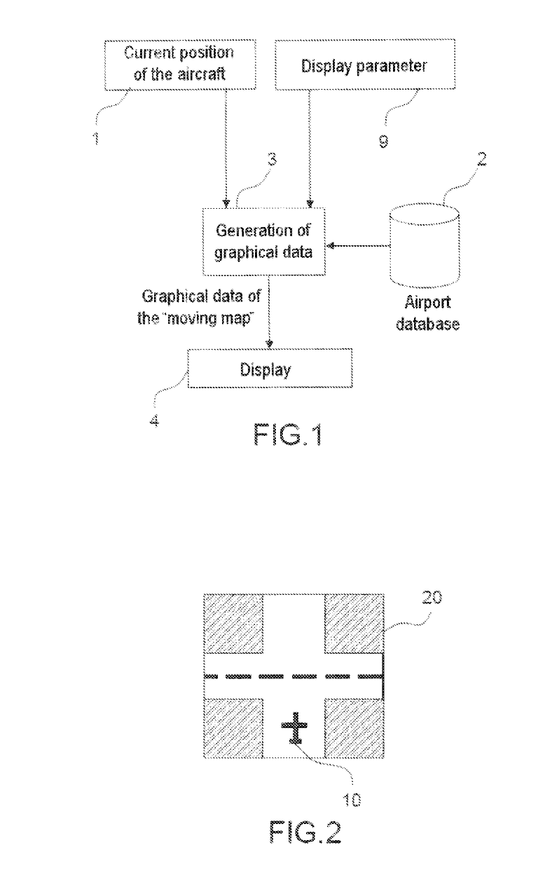

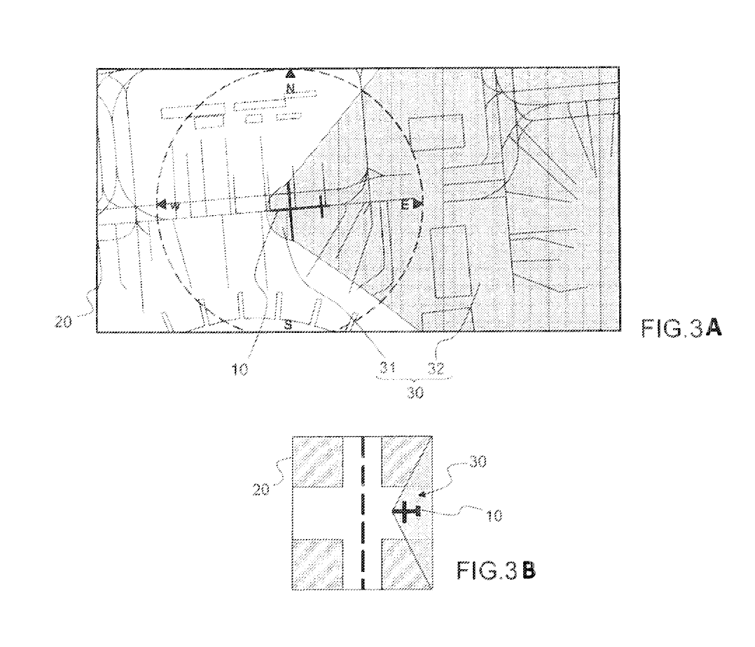

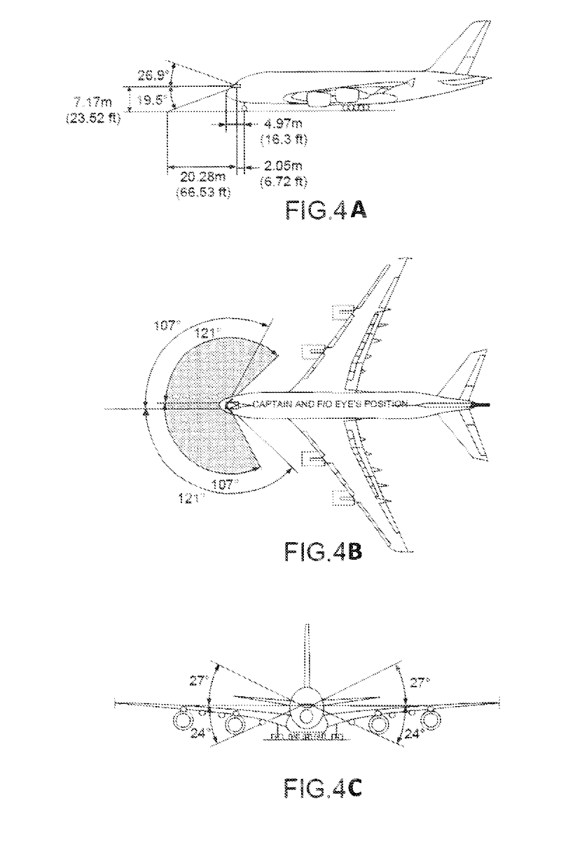

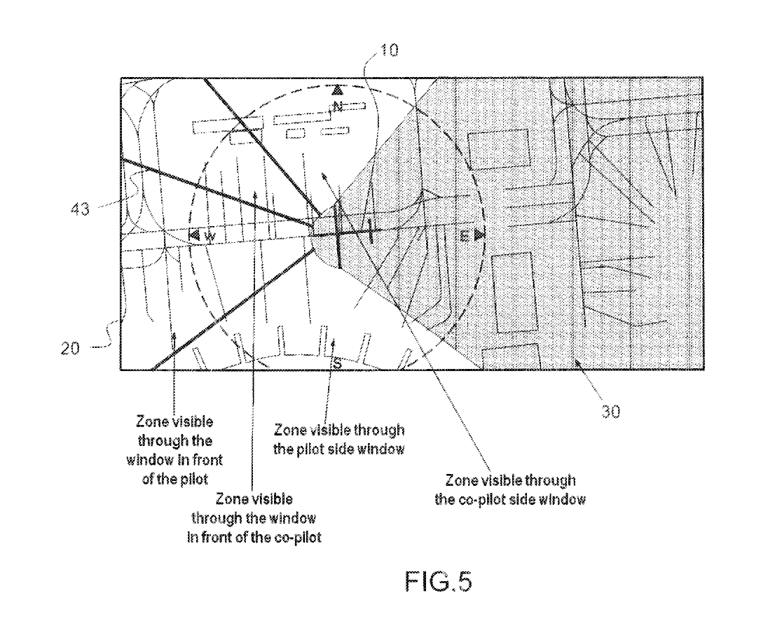

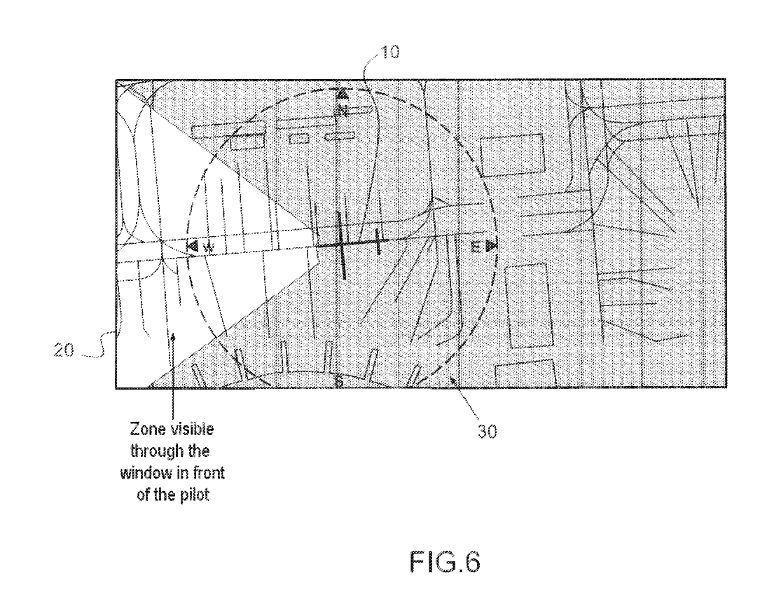

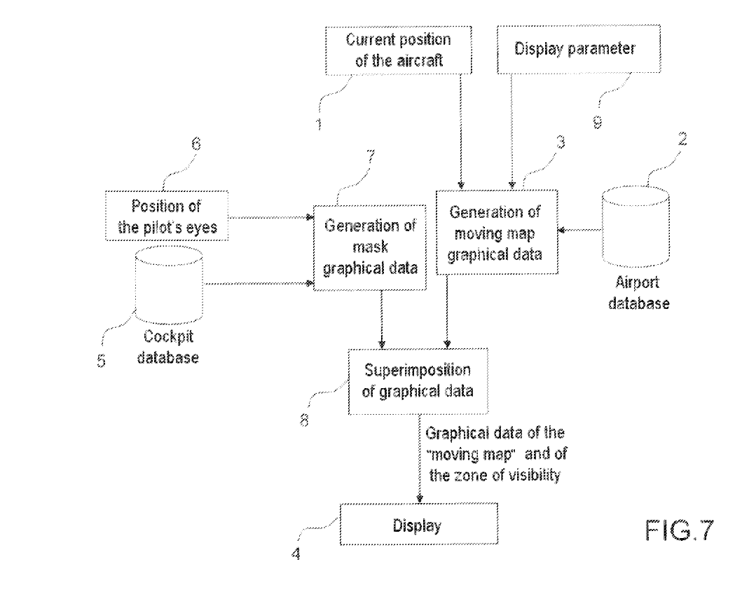

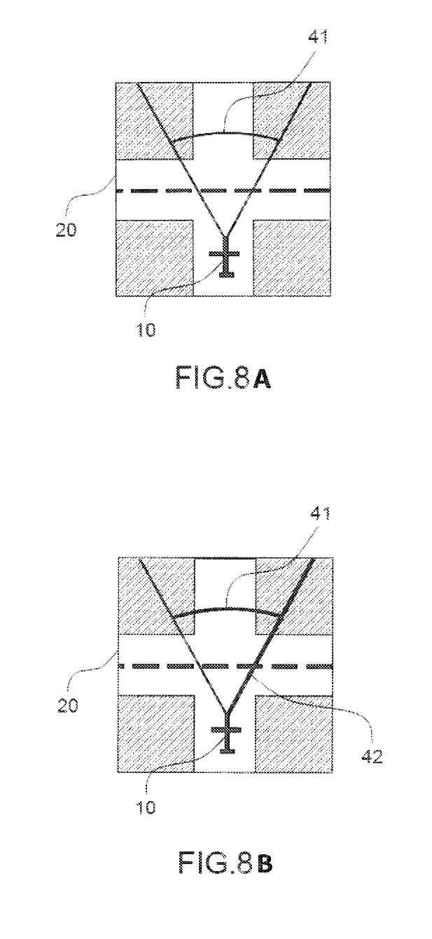

This zone of visibility represented by this mask is determined in different ways by the system according to the invention shown in FIG. 7. The latter comprises, in addition to the elements of the system shown in FIG. 1:
a database 5 in which are stored the features of the cockpit (height, shape of the cockpit, shape of the widows, etc.), which are shown in FIG. 4,
preferably, means 6 for determining the position of the pilot's eyes,
a device 7 for generating second graphical data representing the zone of visibility using the mask,
means 8 for superimposition of the second graphical data on the first graphical data, connected to the display device 4.

According to a variant embodiment, the device 3 for generating first graphical data, the device 7 for generating second graphical data and the means 8 of superimposition can be integrated in an overall device for generating graphical data representing the “moving map” and the mask.

During the use of a head up sight or HUD (Head Up Display), the zone of visibility intended to be displayed can have a predetermined angular dimension (the viewing angle in relative bearing of the installed HUD typically has a value included in the range from 35° to 40°.

When it is intended to be displayed on an instrument panel screen, it is advantageously determined by the system according to the invention as a function of:
features of the cockpit (height, shape of the cockpit, shape of the windows, etc.) illustrated in FIG. 4,
and preferably also as a function of the position of the eyes of the aircraft's pilot; this can be a predetermined average position, or adjusted by the pilot by means of an interface 6 notably as a function of his size and his position in the cockpit according to whether he is occupying the co-pilot's seat (on the right) or that of the captain (on the left), or again it can be detected by a position detection device 6.

It can also be displayed on a helmet mounted sight or HMD (Helmet Mounted Display), or on night vision goggles or NVG (Night Vision Goggles). In this case, the zone of visibility is slaved to the movement of the head detected by a position detection device.

Once the graphical data of the zone of visibility have been determined, they are superimposed on the graphical data of the “moving map” by the superimposition means 8, all of these data then being transmitted to the display device 4.

It is also possible to represent, by delimitations 43, the parts visible from the different windows as well as the blind zones, these delimitations being determined by the device 7 for generating second graphical data from the features of the cockpit. This is illustrated in FIG. 5.

The pilot can decide to restrict the zone of visibility to the vision from a single window, for example the one facing him as illustrated in FIG. 6.

The zone of visibility can advantageously be enhanced by adding, for example, the HUD zone of visibility possibly enhanced with graphical symbols. Examples of graphical symbols are shown on FIGS. 8A and 8B, each representing a symbolic representation of a moving map with a mask whose segments delimiting it, can be modified according to different situations.
The horizontal visibility range or RVR (Runway Visual Range) can be graphically represented in the form of an arc of circle 41 as shown in FIG. 8A, the distance for this arc being provided by the airport (in VHF phonic form, etc. or by data link of the CPDLC (Controller Pilot Data Link Communications) type, and/or adjusted manually by the crew, for example via a rotary control or equivalent. As the angular sector can be opacified for specific values for example during the setting up of LVP (Low Visibility Procedure) procedures, the taxiing guidance is therefore perceived solely in the HUD (through symbology), the close outside environment no longer being visible.
The surrounding traffic in the sense of threats, represented for example by changing the colour of the segment delimiting the zone on the side of the threat, or even the colour of the symbol of the aircraft when the threat comes from the rear (colour logic consistent with that used in the current TCAS or that being developed in the ATSAW Surf systems). This is illustrated in FIG. 8B where a first threat coming from the right induces a modification of the segment 42, and a second threat coming from the front and closer than the first threat induces a modification of the arc 41. These threats are communicated by a warning system of the ATSAW-Surf (Air Traffic Situational Awareness on the Airport Surface) type, connected to the device 7 for generating second graphical data.

This is particularly advantageous during low visibility or LVP operations. This makes it possible to provide HUD references in order to allow cross-checks between the pilot in charge of navigation and the pilot in charge of taxiing, looking outside through the HUD. Thanks to these symbols, the pilot in charge of taxiing can have information on what the other pilot sees in the HUD.

What is claimed is:

1. An on-board optoelectronic system to assist the taxiing of an aircraft on the taxiways of an airport, comprising:
a database (2) of geographical maps of the airport as seen from above,
a device (1) for positioning the aircraft, and
a device (3) for generating first graphical data representing a map of the airport as seen from above and the current position of the aircraft on the said map, called “moving map” graphical data,
a graphical data display device (4),wherein, with the aircraft comprising a cockpit, it furthermore comprises:
a database (5) describing the features of the cockpit,
a device (7) for generating second graphical data according to the said features, representing a zone of visibility from the cockpit by means of a mask (30), and
means of superimposition (8) of the second graphical data on the first graphical data, connected to the display device (4).

2. The system to assist the taxiing of an aircraft according to claim 1, wherein the features of the cockpit relate to the shape and/or the height of the cockpit and/or the shape of the windows.

3. The system to assist the taxiing of an aircraft according to claim 1, wherein it comprises a module (6) for determining the position of the aircraft pilots eyes connected to the device (7) for generating second graphical data, the zone of visibility also being determined as a function of the position of the pilot's eyes.

4. The system to assist the taxiing of an aircraft according to claim 1, wherein the device (7) for generating second graphical data is connected to a warning system and in that the second graphical data comprise information on the surrounding traffic coming from this warning system.

5. The system to assist the taxiing of an aircraft according to claim 1, wherein the device (7) for generating second graphical data is connected to a head up sight and in that the second graphical data comprise information on the surrounding traffic coming from the head up sight.

6. The system to assist the taxiing of an aircraft according to claim 1, wherein the device (7) for generating second graphical data is connected to an air traffic control system and in that the second graphical data comprise information on visibility conditions such as fog.

7. The system to assist the taxiing of an aircraft according to claim 1, wherein the mask (30) comprises delimitations (43) delimiting sub-zones of the zone of visibility.
